(19) United States
(12) Patent Application Publication
(10) Pub. No.: US 2005/0216484 A1
(43) Pub. Date: Sep. 29, 2005

(54) Accessability synopsis containers for large data sets

(76) Inventors: Joseph E. Firebaugh, Apex, NC (US); Robert C. Leah, Cary, NC (US); Warren Williams, Raleigh, NC (US)

Correspondence Address: COATS & BENNETT, PLLC, P O BOX 5, RALEIGH, NC, 27602, US

(21) Appl. No.: 10/809,133

(22) Filed: Mar. 25, 2004

(51) Int. Cl. G06F 17/00

(52) U.S. Cl. 707/100

(57) ABSTRACT

The use of accessibility devices such as a screen reader is facilitated by synopsizing large data sets in a synopsis container data structure. A synopsis of the large data set is generated and included in the synopsis container. The large data set is also included in the synopsis container. The synopsis container may include additional attributes, such as a flag indicating whether or not to output the large data set. In one embodiment the synopsis container is an HTML data structure defined by HTML tags using a CONTAINER keyword. The data structure includes the large data set, formatted as an HTML TABLE or the like. A conventional browser display may output the large data set, and an accessibility system such as a screen reader may output only the synopsis of the large data set.

### BACKGROUND

The present invention relates generally to the field of computers and in particular to a method of providing synopsis containers in a markup language to summarize large data sets to facilitate comprehension by users with accessibility aids.

Computers are ubiquitous in modern society, and utilized daily by millions of people for a wide variety of tasks, including accessing web pages from the World Wide Web of the Internet. However, physical disabilities preclude many people from utilizing a computer for such purposes. In particular, those with visual impairments often cannot see the web pages displayed on their computer's display device. To address this need, a variety of devices are available, collectively referred to herein as screen readers. Implemented as add-on cards or in software, screen readers covert text displayed on the computer's display to audible speech. The screen reader functionality allows many visually impaired individuals to utilize a computer for a variety of tasks, including accessing websites from the Internet.

However, in many cases, the functionality of the screen reader does not render web pages accessed from the Internet particularly useful. For example, many web pages include tables and other data structures containing large amounts of information, which the screen reader converts to speech. For example, a table five columns wide with twenty rows contains 100 elements, each of which will be read to the user by the screen reader. Sighted individuals typically scan such tables, focusing only on items or elements of relevance or interest. This is not possible in the case of a screen reader, which can only convert the entire data set to an audible format.

As an example of this problem, consider the HTML code of FIG. 2 and the corresponding browser display of FIG. 3. In this example, the status of a plurality of computers is displayed in the form of a table. The HTML code of FIG. 2 may, for example, be automatically generated by a network monitoring application, allowing a technician to remotely monitor the status of a network via the Internet.

The elements of the HTML code of FIG. 2 are well known. The code includes an <HTML> tag 52, a <BODY> tag 54, and a header 56. A <TABLE> tag 58 defines the start of a table, the rows and corresponding data of which are defined in the block indicated generally by the numeral 60. The table is terminated by an </TABLE> tag 61, followed by an </BODY> tag 62 and </HTML> tag 64. The syntax and function of the HTML tags are well known in the art and not further explicated herein.

FIG. 3 depicts a browser window 66 displaying the HTML code 50 of FIG. 2. The header 68 is displayed, followed by the table information 70, as defined by the table data structure 60. A sighted individual, upon viewing the table 70, would briefly note the elements having a “normal” status (and largely ignore the information associated with them), and quickly zero in on the one “fatal” and two “critical” elements, taking note of the associated identification information. A screen reader, however, is incapable of such “intelligent” assessment, and would simply read every table element. While this does convey the information displayed in the table to a visually impaired user, the important information is likely to be lost in the “noise” of the totality of information. Additionally, the screen reader will take considerably more time to read the table than is required by a sighted individual, who can visually summarize its contents. A need thus exists to allow the screen reader to present only a summary of the table contents.

### SUMMARY

The present invention relates to a method of synopsizing large data sets to facilitate the use of an accessibility system. The method includes providing a large data set and formatting the large data set for transmission, generating a synopsis of the large data set and formatting the synopsis of the large data set in a synopsis container. The synopsis container, including both the large data set and the synopsis of the large data set, is then transmitted to a computer having an accessibility system.

In another aspect, the present invention relates to a markup language data structure for synopsizing a large data set. The data structure includes a data structure initial tag, at least one attribute comprising a synopsis of the large data set, a markup language data structure containing the large data set and a data structure terminating tag.

### BRIEF DESCRIPTION OF DRAWINGS

FIG. 1 is a functional block diagram of a computer having a screen reader.

FIG. 2 is an example of prior art HTML code including a large data set.

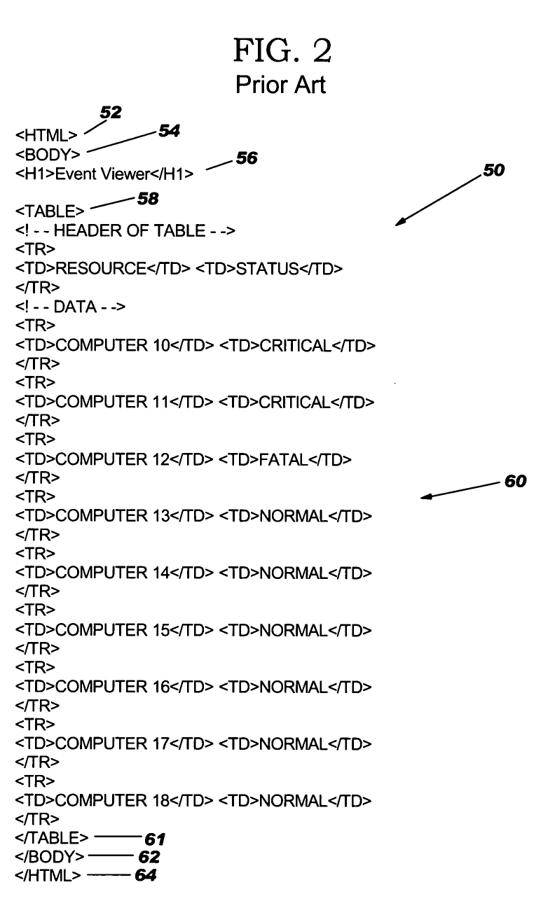

FIG. 3 is a web browser displaying the prior art HTML code of FIG. 2.

FIG. 4 is an example of HTML code including a synopsis container.

FIG. 5 is a web browser displaying the HTML code of FIG. 4.

FIG. 6 is a flow diagram of a method of synopsizing a large data set.

### DETAILED DESCRIPTION

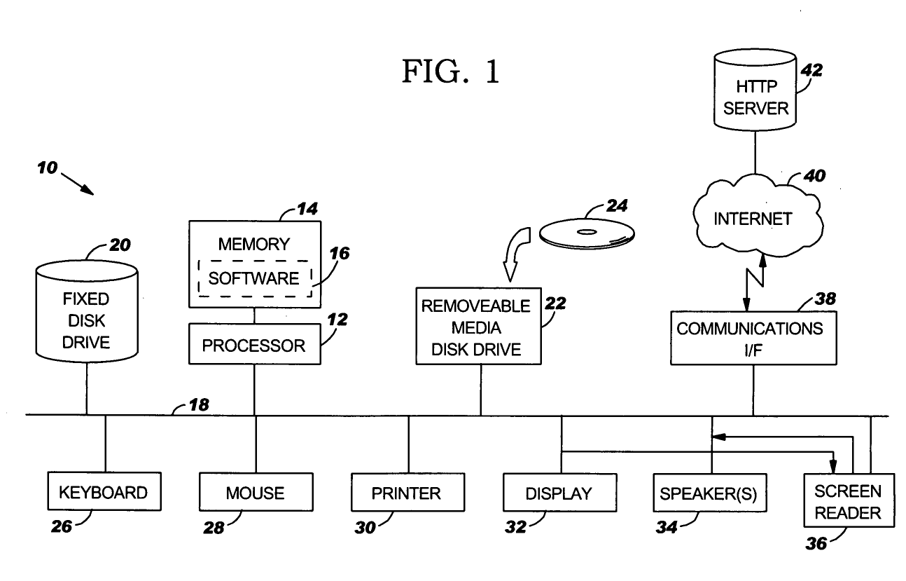

FIG. 1 depicts a functional block diagram of a representative computer system, indicated generally by the numeral 10. The computer system 10 includes a processor 12 capable of executing stored instructions. Connected to the processor 12 is memory 14 that, in operation, stores software 16. Software 16 may include, in addition to operating systems and the like, communications software and a web browser application that displays data to a user from an HTTP (web) server 42.

The processor 12 is connected to a bus 18, to which are connected a variety of data storage devices and input and output devices. For example, a fixed disk drive 20 containing a computer-readable medium, from which software 16 may be loaded into memory 14, may be attached to the bus 18. Additionally, a removable media disk drive 22 that receives removable computer-readable media 24 may be attached to the bus 18. The removable media 24 may comprise a floppy disk, a CD-ROM or DVD-ROM, a magnetic tape, high-capacity removable media, or the like. Removable media 24 may contain a variety of digital data, and in particular may contain software 16, such as a web browser application. The software 16 may be copied from the removable media 24 to the fixed disk drive 20, and subsequently loaded into memory 14 from the fixed disk drive 20. Alternatively, the software 16 may be loaded directly from the removable media 24 into the memory 14.

Also connected to the bus 18 are input devices such as a keyboard 26 and a mouse 28, as well known in the art. The computer system 10 may additionally include output devices such as a printer 30, display device 32, and one or more speakers 34. Display device 32 may comprise a traditional CRT monitor, a liquid crystal display (LCD), or the like. A communications interface 38 may additionally connected to the bus 18. The communications interface may provide data communications with a computer network such as the Internet 40. In particular, it may allow the computer 10 to receive web pages from a web server 42, using the Hyper-Text Transfer Protocol (HTTP) as well known in the art. Data received from the HTTP server 42, such as for example data in the Hyper-Text Markup Language (HTML) or a variant thereof (such as XML or the like) may be displayed on the display device 32 by a web browser application in software 16.

A screen reader 36 may comprise a hardware module connected to the bus 18, as depicted in FIG. 1. The screen reader receives information directed to the display 32. The screen reader 36 includes a text-to-speech engine that generates audio corresponding to the text displayed on the display device 32. As depicted in FIG. 1, this audio information is directed from the screen reader 36 to the system speakers 34. Note that the depiction in FIG. 1 is functional. In actual implementation, the screen reader 36 may access text to be displayed on the display device 32 directly from a frame buffer in memory 14 over the bus 18. Similarly, the screen reader 36 may direct audio over the bus 18 to the speakers 34. Alternatively, as will be recognized by those of skill in the art, the entire screen reader functionality 36 may be implemented in a software application 16 executed by the processor 12, accessing memory 14 and driving speakers 34.

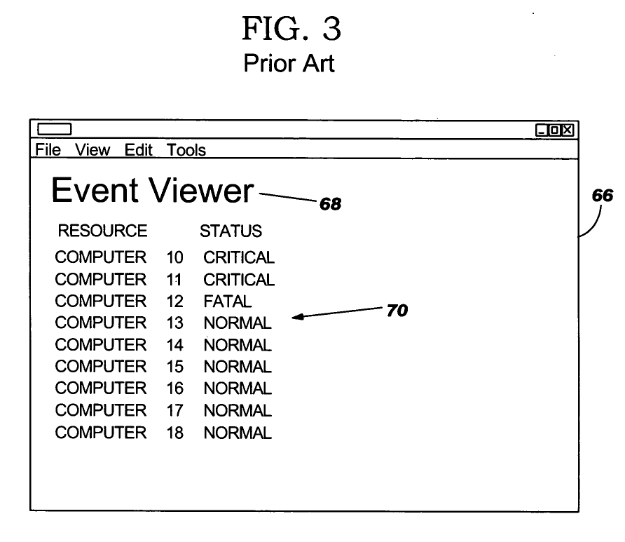

As discussed above, a significant deficiency of the screen reader of the prior art is the inability to summarize large data sets, such as the table 70 of FIG. 3. According to the present invention, a new data structure is defined, referred to herein as a “synopsis container.” The synopsis container is a superset of (and thus “contains”) a large data set. The synopsis container additionally contains a summary or synopsis of the large data set. The synopsis container may additionally contain additional elements, such as a flag indicating whether or not the large data set is to be displayed. Alternatively, this decision may be left to individual computer output devices.

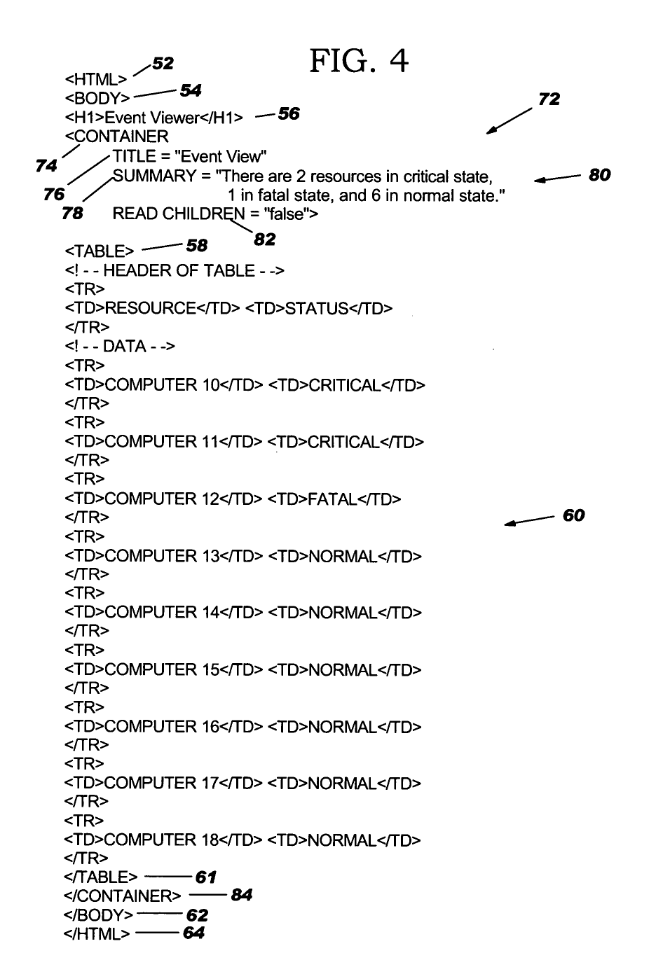

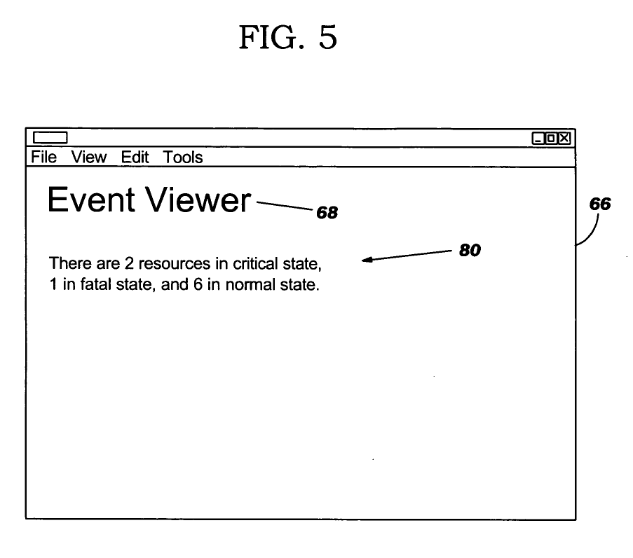

One embodiment of a synopsis container according to the present invention, implemented as an extension to the Hyper-Text Markup Language (HTML). In this embodiment, HTML tags <CONTAINER> and </CONTAINER> are added, and define the boundaries of the synopsis container. Note that other tags may be substituted for the word CONTAINER. The syntax and operation of the CONTAINER tag is depicted in FIGS. 4 and 5.

The synopsis container is defined in HTML code 72 by the <CONTAINER> tag 74 and the </CONTAINER> tag 84. Note that the synopsis container includes, or “contains” a large data set (in this example, the table 60). This is indicated by the <TABLE> and </TABLE> tags 58, 61 being within the <CONTAINER> and </CONTAINER> tags 74, 84, in the well known hierarchical structure of HTML code. The synopsis container optionally includes a title, assigned to the attribute TITLE 76. The synopsis container also includes a summary 80, assigned to a SUMMARY attribute 78. The summary 80 is an abstract or synopsis of the information contained in the associated large data set. The summary 80 may be automatically generated, or alternatively, may be written by an individual summarizing the contents of the data set. A flag, such as the READ_CHILDREN attribute 82 may be assigned a value indicating whether or not the accompanying large data set items are to be displayed. Additional attributes for the synopsis container may be defined, as necessary or desired. Also, note that the attributes TITLE 76, SUMMARY 78 and READ_CHILDREN 82 may be renamed.

FIG. 5 depicts the browser window 66 displaying the HTML code 72. The header 68 (outside of the synopsis container) is displayed, as in FIG. 3. The table information 70, however, is replaced with the summary 80, indicating the salient information from the associated table 70. Because the READ_CHILDREN flag 82 was set to false, the table information 70 is not displayed in FIG. 5.

The container tag may be recognized and implemented only by screen readers 36 and similar applications. That is, a typical web browser running on a computer 10 without special accessibility hardware or software, may ignore the CONTAINER keyword, and display the associated large data set, as depicted in FIG. 3. Accessibility-equipped computers 10, such as those including a screen reader 36, may interpret the CONTAINER tag and output the summary 80 of the associated large data set, rather than the entire large data set itself.

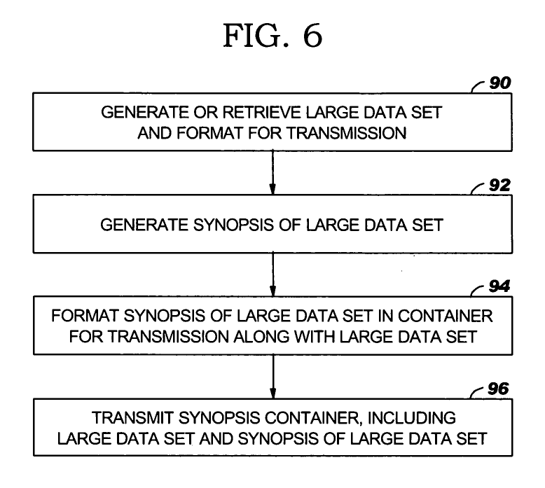

FIG. 6 depicts a method of providing large data sets in a synopsis container, such as by the HTTP server 42, according to the present invention. The web server generates or retrieves a large data set and formats it for transmission at step 90. This may comprise, for example, generating or accessing requested information, and dynamically generating HTML code to format and display the large data set. The dynamic generation and formatting of large data sets is well known. For example, many merchant sites perform a search of available products from a database in response to keywords provided by a user, and return large data sets, formatted as HTML tables or other data structures. As another example, a variety of real-time monitoring systems generate large data sets and format the data as HTML tables or the like in response to a status query from a user.

At step 92, the server 42 generates a summary or synopsis of the contents of the large data set. This may be done automatically, for example, by identifying key terms or parameters within the data set, and generating a count of the key terms or parameters falling within certain predetermined values. Alternatively, for static large data sets, generating the synopsis may comprise an analysis or review by an individual, who writes a summary of the salient features or parameters of the large data set.

At step 94, the large data set and the synopsis of the large data set are together assembled into a synopsis container, as described above. Note that this step may be combined with step 90, for example, generating HTML code of the large data set and its synopsis simultaneously. Finally, the synopsis container, including both the large data set and the synopsis of the large data set, are transmitted to one or more client terminals, such as the computer 10, at step 96.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of synopsizing large data sets to facilitate the use of an accessibility system, comprising:
providing a large data set and formatting said large data set in a markup language data structure;
generating a synopsis of said large data set;
formatting said synopsis of said large data set in a synopsis container that includes said large data set and said synopsis of said large data set; and
transmitting said synopsis container to a computer having an accessibility system.

2. The method of claim 1 wherein providing a large data set comprises automatically generating said large data set in response to a user input.

3. The method of claim 1 wherein providing a large data set comprises retrieving said large data set from storage in response to a user input.

4. The method of claim 1 wherein formatting said large data set for transmission comprises generating markup language data structures to direct the display of said large data set at a client terminal.

5. The method of claim 1 wherein generating a synopsis of said large data set comprises automatically generating said synopsis by comparing data elements in said large data set to predetermined metrics.

6. The method of claim 1 wherein generating a synopsis of said large data set comprises writing said synopsis by an individual.

7. The method of claim 1 wherein formatting said synopsis of said large data set in a synopsis container comprises generating a markup language data structure defining said synopsis container.

8. The method of claim 1 wherein transmitting said synopsis container comprises transmitting a markup language data structure including said large data set and said synopsis.

9. The method of claim 1 wherein said accessibility system is a screen reader.

10. A markup language data structure for synopsizing a large data set, comprising:
a data structure initial tag;
at least one attribute comprising a synopsis of said large data set;
a markup language data structure containing said large data set; and
a data structure terminating tag;

11. The data structure of claim 10 further comprising a flag attribute indicating whether or not to output said large data set.

12. The data structure of claim 10, wherein said data structure is associated with the keyword CONTAINER.

13. The data structure of claim 10 wherein said data structure initial tag is <CONTAINER> and said data structure terminating tag is </CONTAINER>.

14. The data structure of claim 10 wherein said data structure is compatible with the Hyper-Text Markup Language.

15. A computer readable medium including one or more computer programs operative to cause a computer to generate and transmit a synopsis container for a large data set, the computer programs causing the computer to perform the steps of:
formatting said large data set in a markup language data structure;
generating a synopsis of said large data set;
formatting said synopsis of said large data set in a synopsis container that includes said large data set in said markup language data structure; and
transmitting said synopsis container to a computer having an accessibility system.

16. The computer readable medium of claim 15 wherein said accessibility system comprises a screen reader.

17. A computer comprising:
a screen reader operative to generate speech corresponding to text to be displayed on a computer display; and
a communications port operative to receive at least one web page from a web server;
wherein said screen reader is operative to recognize a synopsis container in a web page, said synopsis container including a large data set and a synopsis of said large data set, and to generate speech corresponding to said synopsis of said large data set.

18. The computer of claim 17 wherein said screen reader does not generate speech corresponding to said large data set.
